(19) United States
(12) Patent Application Publication
(10) Pub. No.: US 2009/0253421 A1
(43) Pub. Date: Oct. 8, 2009

(54) LOCAL NETWORK MANAGEMENT OF FEMTOCELLS

(75) Inventors: William O. Camp, JR., Chapel Hill, NC (US); Gary Cole, Cary, NC (US); Walter M. Marcinkiewicz, Chapel Hill, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/061,069

(22) Filed: Apr. 2, 2008

(51) Int. Cl. H04Q 7/20; H04M 3/22

(52) U.S. Cl. 455/418; 455/423

(57) ABSTRACT

A system and method of minimizing signal interference within a wireless network is provided, wherein the wireless network includes a controller communicatively coupled to at least one femtocell, and the femtocell is operative to wirelessly transmit and receive data. A portable electronic device is used to collect signal environment data, and the collected signal environment data is analyzed. Based on the analyzed signal environment data, the at least one femtocell is commanded to alter at least one signal transmission characteristic.

### TECHNICAL FIELD OF THE INVENTION

The present invention relates generally to electronic devices, such as electronic devices for engaging in voice communications. More particularly, the invention relates to a system, device and method for managing femtocell operation in a communication network so as to minimize signal interference.

### DESCRIPTION OF THE RELATED ART

A femtocell (also referred to as an Access Point Base Station) is a small cellular base station, typically designed for use in residential or small business environments. The femtocell connects to a service provider's network via a broadband connection (such as DSL or cable). The femtocell allows service providers to extend service coverage indoors, especially where access would otherwise be limited or unavailable. More specifically, the femtocell incorporates the functionality of a typical radio base station, but extends it to allow a simpler, self contained deployment.

For a user, the attractions of a femtocell are improvements to both coverage and capacity, particularly indoors. The cellular operator also benefits from the improved capacity and coverage, but also can reduce both capital expenditure and operating expense.

### SUMMARY

Without unique spectrum for the femtocell ‘underlay network’, or very careful spectrum planning in the wider network, femtocells could suffer from interference problems. For example, in a high-rise apartment complex environment, a number of femtocells may be placed near each other, and may be separated only by the floor and/or walls of adjacent apartment units. If these femtocells operate on the same channel, then one femtocell may interfere with the operation of the other femtocell, and vice-versa. Further, if a single frequency CDMA system is being operated, where a macro network and femtocell network utilize the same frequency band (a typical situation for many operators who licensed only one 3 G frequency band), then the power control algorithms of the macro cell and femtocell can create interference, where for example a mobile unit increases its transmit power to the femtocell as part of the ‘near-far’ power control inherent in CDMA systems, while it is within the coverage area of a macro unit. The resultant high power transmitter in the macro field acts as an interferer since the frequency is shared.

A system, device and method in accordance with the present invention enables management of a network of femtocells so as to minimize the likelihood of signal interference. More particularly, an electronic device, such as a mobile phone or the like, monitors a signal environment and transmits data regarding the signal environment to a controller (e.g., a base station controller or the like). The controller, based on the collected information regarding the signal environment, alters operational characteristics of the femtocells so as to minimize the likelihood of interference (e.g., minimize interference between femtocells and/or interference between femtocells and radio base stations of a wide-area network). To minimize interference, the controller, for example, can command the femtocells to alter power transmission levels, frequencies and/or spreading codes.

Additionally, GPS functionality employed in many electronic devices can be used to map a local femtocell network. For example, the electronic device can determine its location using a built-in GPS receiver. The electronic device can transmit its location (as determined from the GPS receiver) along with information regarding the signal environment to the base station controller. The base station controller then can map the local femtocell network based on the received information, and proactively configure the network so as to minimize the likelihood of signal interference.

According to one aspect of the invention, a method of minimizing signal interference within a wireless network, the wireless network including a controller communicatively coupled to at least one femtocell, wherein the femtocell is operative to wirelessly transmit and receive data, the method including: using a portable electronic device to collect signal environment data; analyzing the collected signal environment data; and based on the analyzed signal environment data, commanding the at least one femtocell to alter at least one signal transmission characteristic.

According to one aspect of the invention, commanding is performed by the controller.

According to one aspect of the invention, using the portable electronic device further includes communicating the collected signal environment data to the controller.

According to one aspect of the invention, analyzing the collected signal environment data includes at least one of: comparing a power level of the at least one femtocell to a power level of a radio base station of the wireless network; or comparing a power level of the at least one femtocell to a general interference present in the signal environment data.

According to one aspect of the invention, analyzing further includes determining from the analyzed signal environment data that interference is likely if the compared power levels are within a predetermined range of one another.

According to one aspect of the invention, the method further includes: detecting a location of the portable electronic device; and associating the collected signal environment data with the detected location of the portable electronic device.

According to one aspect of the invention, associating includes storing the detected location and the collected signal environment data in a database accessible by the controller.

According to one aspect of the invention, detecting the location of the portable electronic device includes using a global positioning system (GPS) receiver of the portable electronic device to determine the location.

According to one aspect of the invention, altering at least one signal transmission characteristic includes changing at least one of i) a transmission frequency of the at least one femtocell, ii) a transmission power level of the at least one femtocell, or iii) a transmission spreading code of the at least one femtocell.

According to one aspect of the invention, collecting signal environment data includes collecting data regarding signal strengths from a serving femtocell, a non-serving femtocell, and/or a radio base station of the wireless network.

According to one aspect of the invention, wherein the at least one femtocell comprises a serving femtocell and a non-serving femtocell, the method further comprising determining from the collected signal environment data if interference is likely between the serving femtocell and the non-serving femtocell.

According to one aspect of the invention, commanding the at least one femtocell includes commanding the non-serving femtocell.

According to one aspect of the invention, commanding the at least one femtocell includes commanding a serving femtocell.

According to one aspect of the invention, a system for minimizing signal interference within a wireless network includes: a controller; at least one femtocell communicatively couplable to the controller; and at least one portable electronic device communicatively couplable to the controller, wherein the at least one portable electronic device is operative to collect signal environment data and communicate the collected signal environment data to the controller, and wherein the controller is operative to analyze the signal environment data and, based on the analysis, command the at least one femtocell to alter signal transmission characteristics so as to minimize signal interference within the wireless network.

According to one aspect of the invention, the controller is operative to compare power levels of the at least one femtocell to power levels of a radio base station of the wireless network, and/or compare a power level of the at least one femtocell to a general interference present in the signal environment data.

According to one aspect of the invention, the controller is operative to determine from the analyzed signal environment data that interference is likely if the compared power levels are within a predetermined range of one another.

According to one aspect of the invention, the electronic device is operative to detect its current location and communicate the detected location to the controller, and the controller is operative to map femtocells in the network by associating the collected signal environment data with the detected location of the electronic device.

According to one aspect of the invention, the controller is operative to store the map in a database.

According to one aspect of the invention, the controller is operative to command the at least one femtocell to alter at least one of i) a transmission frequency of the at least one femtocell, ii) a transmission power level of the at least one femtocell, or iii) a transmission spreading code of the at least one femtocell.

According to one aspect of the invention, the electronic device is operative to collect data regarding signal strengths from a serving femtocell, a non-serving femtocell, and/or a radio base station of the wireless network.

According to one aspect of the invention, the electronic device is at least one of a mobile phone, pager, electronic organizer, personal digital assistant, or smartphone.

According to one aspect of the invention, A base station controller for controlling the operation of at least a portion of a wireless wide-area network, the controller couplable to at least one femtocell includes: a processor and memory; and logic stored in the memory and executable by the processor, the logic including logic that determines configuration parameters for at least one femtocell based on signal environment data of the wireless network.

According to one aspect of the invention, the controller further includes: a broadband interface for communicating with the at least one femtocell; and a radio base station interface for communicating with at least one radio base station.

According to one aspect of the invention, a method of minimizing signal interference within a wireless network including at least one femtocell operative to wirelessly transmit and receive data includes: using a portable electronic device to collect signal environment data; and based on the collected signal environment data, commanding the at least one femtocell to alter at least one signal transmission characteristic so as to minimize signal interference within the wireless network.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a block diagram illustrating an exemplary communications network including a wireless base station, radio base stations, and femtocells.

FIG. 2 is a schematic view of a mobile telephone as an exemplary electronic device in accordance with an embodiment of the present invention.

FIG. 3 is a schematic block diagram of the relevant portions of the mobile telephone of FIG. 2 in accordance with an embodiment of the present invention.

FIG. 4 is a schematic block diagram of the relevant portions of an exemplary base station controller in accordance with an embodiment of the present invention.

FIG. 5 is a flow chart of an exemplary method for using the mobile phone of FIG. 2 to monitor and communicate the signal environment to the base station controller of FIG. 4 in accordance with an embodiment of the present invention.

FIG. 6 is a flow chart of an exemplary method for managing a local network of femtocells in accordance with an embodiment of the present invention.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which hereinafter is referred to as a “mobile radio terminal,” includes all equipment such as mobile telephones, pagers, communicators, electronic organizers, personal digital assistants (PDAs), smart phones, portable communication apparatus, portable gaming devices, portable media devices (video and/or audio), and the like.

In the present application, embodiments of the invention are described primarily in the context of a mobile telephone and/or a mobile telephone communication network. However, it will be appreciated that the invention is not intended to be limited to the context of a mobile telephone and may relate to any type of appropriate electronic equipment and/or network.

Portable electronic devices, such as mobile telephones, typically communicate to a service provider's communication network via a plurality of radio base stations (e.g., radio towers), wherein each radio base station is coupled to a base station controller, which in turn is coupled to the service provider's main switching network. Via the radio base stations and base station controllers, the electronic device can remain in communication with the service provider's network as the electronic device moves from one region to another, thereby enabling voice communications, data exchange, etc. over a vast area.

Despite the ever increasing number of radio base stations being deployed throughput the world, there remains the possibility that the electronic device cannot establish communications with a radio base station. This can be due to signal interference, for example, or simply due to the distance between the electronic device and the nearest radio base station.

To address the above problem, femtocells have been utilized. A femtocell is a wireless device that provides an alterative connection path to the wireless service provider's network. Generally speaking, the femtocell includes a wireless transceiver for communication with a portable electronic device, such as a mobile telephone, wherein the wireless transceiver may incorporate any conventional air interface. In addition to the wireless transceiver, the femtocell also includes a broadband connection, which may be a wired or wireless connection to the service provider's base station controller. The femtocell also includes logic that bridges the air interface to the broadband interface, thereby enabling communication with base station controller (and thus the network). Accordingly, in addition to network access via the radio base stations, the electronic device also may access the network via the femtocell.

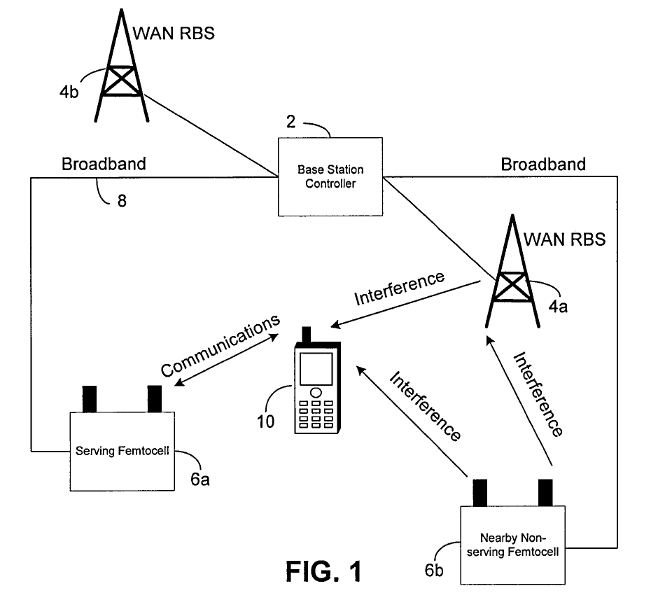

FIG. 1 illustrates an exemplary communication network that includes a plurality of femtocells. More particularly, a base station controller 2 is communicatively coupled (preferably a wired connection) to a plurality of radio base stations 4a and 4b as is conventional. The radio base stations 4a and 4b may be conventional radio towers dispersed throughout a region to form a wide area network (WAN). Although only two radio base stations are shown, it will be appreciated that many such base stations can exist within a given area.

Additionally, a plurality of femtocells 6a and 6b are communicatively coupled to the base station controller 2 via a broadband connection 8. Again, although only two femtocells are shown in FIG. 1, there may be many more femtocells in the network. The broadband connection 8 may be a conventional high speed data connection, and may include at least partial connections via the internet. Alternatively, the broadband connection may be a dedicated connection for use only by femtocells 6a and 6b and the base station controller 2. An electronic device 10, such as a mobile phone or the like, communicates to the base station controller 2 via a first femtocell 6a (also referred to as a serving femtocell), as represented by the line with arrowheads on both ends.

It is noted that although both the WAN (the radio base stations) and femotcells are shown as being managed by a single base station controller 2, there may be one or more base station controllers dedicated to femtocell management, and one or more base stations dedicated to WAN management. These dedicated base stations can be communicatively coupled to one another so as to permit the exchange of information in accordance with the invention. In this sense, the multiple base station controllers can act as a single controller for both types of base stations (WAN and femtocell).

Since femtocells may be deployed by individuals not affiliated with the service provider (i.e., the network operator or owner), some femtocells (e.g., femtocell 6b) may interfere with communications between the electronic device 10 and a serving femtocell (e.g., femtocell 6a). Further, operation of the femtocell may cause interference with the WAN, and vice-versa. While such interference would not occur in frequency division duplex (FDD) type systems, it may occur for time division duplex (TDD) systems where the femtocell timing is not under strict control of the base station controller. Such interference is illustrated in FIG. 1 by a line having only a single arrowhead from the interfering device to the electronic device 10.

A system, device and method in accordance with the present invention manages the local network of femtocells 6a and 6b so as to minimize interference between the serving femtocell 6a and the electronic device 10. More particularly, the electronic device 10 acts as the “ears” of the base station controller 2. In this sense, the electronic device 10 monitors a signal environment for other signals that may create interference, and communicates information regarding these signals to the base station controller 2. Communication of this information can be via the serving femtocell 6a, for example, or via the radio base stations 4a and 4b.

Once the base station controller 2 receives the signal environment data from the electronic device 10, it analyzes the data and determines what actions to take. For example, if the base station controller 2 determines from the signal environment data that nearby femtocell 6b may be interfering with the communications between serving femtocell 6a and the electronic device 10 (e.g., the non-serving femtocell 6b may be operating on the same channel as the serving femtocell 6a), the base station controller 2 can instruct the non-serving femtocell 6b to change its transmission frequency (e.g., change its channel), its spreading codes, and/or its transmission power level. Alternatively, if it is determined that the interference is between the femtocell and the WAN, then the base station controller 2 can instruct the serving femtocell 6a and/or the electronic device 10 to change their operating frequencies (e.g., change their channels), transmission power levels and/or spreading codes.

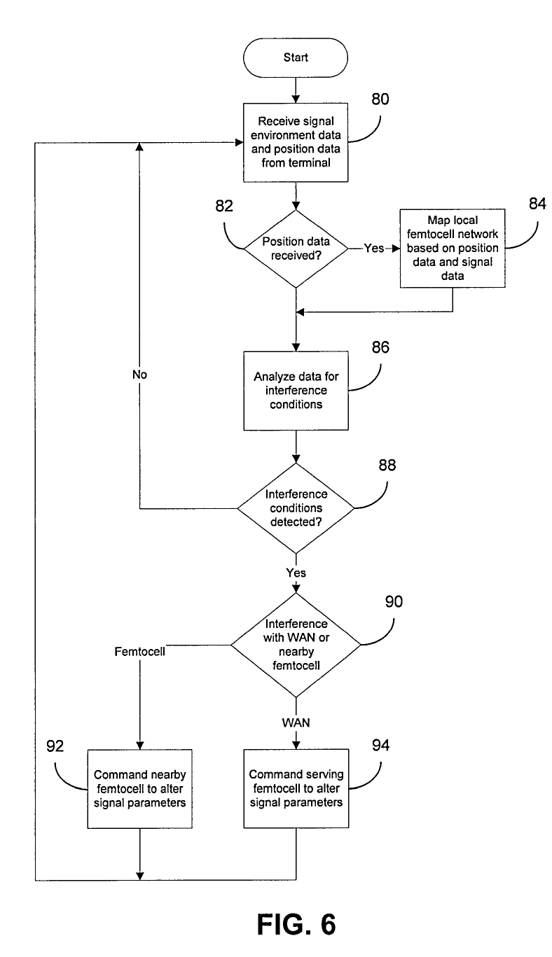

Further, since many electronic devices, such as mobile telephones, include GPS functionality, they can be utilized by the base station controller 2 to map out a femtocell network. More particularly, the electronic device 10 can not only collect information regarding the signal environment, but also collect information regarding its current location (e.g., via GPS). This information can be provided to the base station controller 2, which can use this information to build a network map, which enables the base station controller to optimally configure the network of femtocells so as to minimize the likelihood of interference. More specifically, the base station controller 2 can take a proactive approach to managing the network of femtocells, wherein femtocells that are near each other (i.e., femtocells that may interfere with each other) and/or femtocells that are near a radio base station are configured to minimize the likelihood of interference. This can be accomplished, for example, by setting the femtocells to operate on different channels, altering their transmission power levels, and/or changing their spreading codes. Further details regarding the network management of femtocells is described below with respect to FIGS. 5-6.

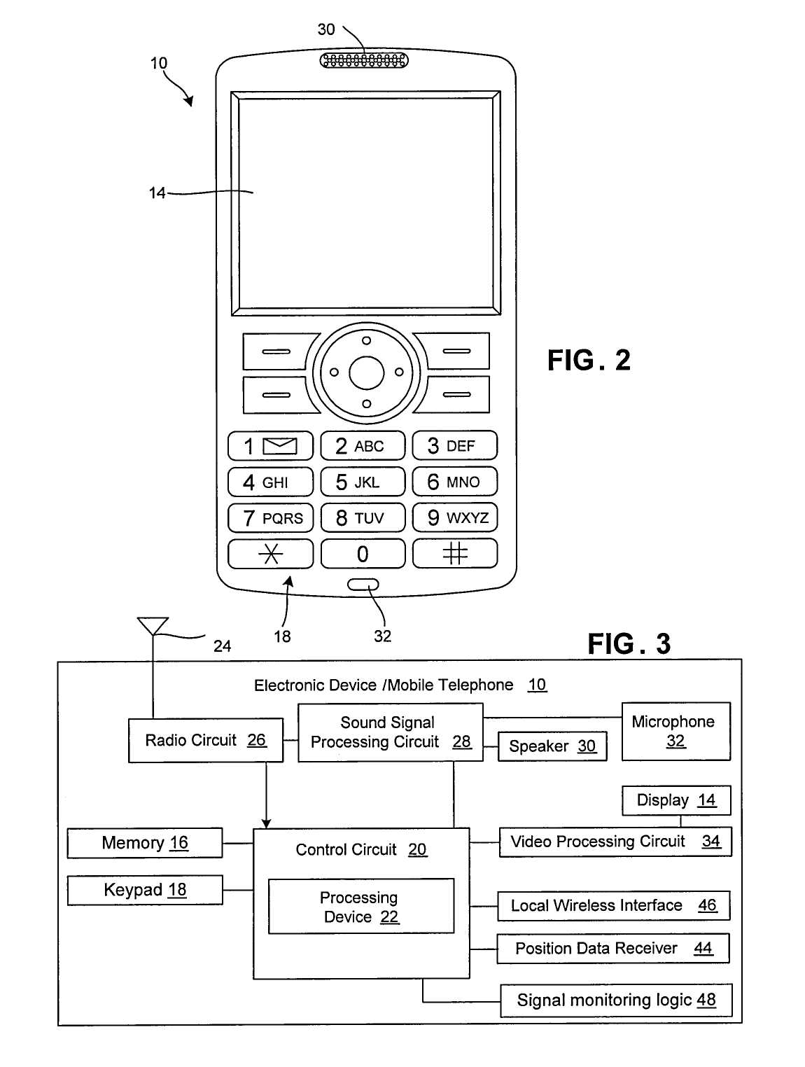

Referring now to FIGS. 2 and 3, an electronic device 10 is shown. The electronic device of the illustrated embodiment is a mobile telephone and will be referred to as the mobile telephone 10. The mobile telephone 10 is shown as having a brick or block form factor, although other form factors, such as a “flip-open” form factor (e.g., a “clamshell” housing) or a slide-type form factor (e.g., a “slider” housing) also my be utilized.

The mobile telephone 10 may include a display 14. The display 14 displays information to a user such as operating state, time, telephone numbers, contact information, various navigational menus, etc., which enable the user to utilize the various features of the mobile telephone 10. The display 14 also may be used to visually display content received by the mobile telephone 10 and/or retrieved from a memory 16 (FIG. 3) of the mobile telephone 10.

A keypad 18 provides for a variety of user input operations. For example, the keypad 18 typically includes alphanumeric keys for allowing entry of alphanumeric information such as telephone numbers, phone lists, contact information, notes, etc. Keys or key-like functionality also may be embodied as a touch screen associated with the display 14.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as a femtocell, an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc.

FIG. 3 represents a functional block diagram of the mobile telephone 10. For the sake of brevity, generally conventional features of the mobile telephone 10 will not be described in great detail herein.

The mobile telephone 10 includes a primary control circuit 20 that is configured to carry out overall control of the functions and operations of the mobile telephone 10. The control circuit 20 may include a processing device 22, such as a CPU, microcontroller or microprocessor. The processing device 22 executes code stored in a memory (not shown) within the control circuit 20 and/or in a separate memory, such as the memory 16, in order to carry out operation of the mobile telephone 10. The memory 16 may include a read only memory area that is implemented using nonvolatile memory, and a random access or system memory area that is implemented using volatile memory.

Continuing to refer to FIGS. 2 and 3, the mobile telephone 10 includes an antenna 24 coupled to a radio circuit 26. The radio circuit 26 includes a radio frequency transmitter and receiver for transmitting and receiving signals via the antenna 24 as is conventional. The radio circuit 26 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 10 further includes a sound signal processing circuit 28 for processing audio signals transmitted by and received from the radio circuit 26. Coupled to the sound processing circuit 28 are a speaker 30 and a microphone 32 that enable a user to listen and speak via the mobile telephone 10 as is conventional. The radio circuit 26 and sound processing circuit 28 are each coupled to the control circuit 20 so as to carry out overall operation. The sound processing circuit 28 may include any appropriate buffers, decoders, amplifiers and so forth.

The display 14 may be coupled to the control circuit 20 by a video processing circuit 34 that converts video data to a video signal used to drive the display 14. The video processing circuit 34 may include any appropriate buffers, decoders, video data processors and so forth.

The mobile telephone 10 also may include a position data receiver 44, such as a global positioning system (GPS) receiver, Galileo satellite system receiver or the like. The position data receiver 14 can determine a location of the mobile telephone 10 as is conventional.

The mobile telephone 10 also may include a local wireless interface 46, such as an infrared transceiver and/or an RF interface (e.g., a Bluetooth interface, WiFi interface, etc.), for establishing communication with an accessory, another mobile radio terminal, a femtocell, a computer or another device.

The mobile telephone 10 also includes signal monitoring logic 48. As described herein, the signal monitoring logic 48 is operative to “listen” to the signal environment, and communicate information regarding the signal environment to the base station controller 2. This communication may be via the radio circuit 26 and/or the local wireless interface 46. The signal monitoring logic also can communicate the mobile telephone's current location (as determined by the position data receiver 44) to the base station controller.

The signal monitoring logic 48 may be in the form of code stored in memory and executed by the processing device. It will be apparent to a person having ordinary skill in the art of computer programming, and specifically in application programming for mobile telephones or other electronic devices, how to program a mobile telephone 10 to operate and carry out logical functions associated with the signal monitoring logic 48 as described herein.

Accordingly, details as to specific programming code have been left out for the sake of brevity. Also, while the signal monitoring logic 48 is executed by the processing device 22 in accordance with a preferred embodiment of the invention, such functionality could also be carried out via dedicated hardware, firmware, software, or combinations thereof, without departing from the scope of the invention. Any of these implementations may be referred to as signal monitoring logic 48. Further details regarding the signal monitoring logic 48 are described below with respect to FIG. 5.

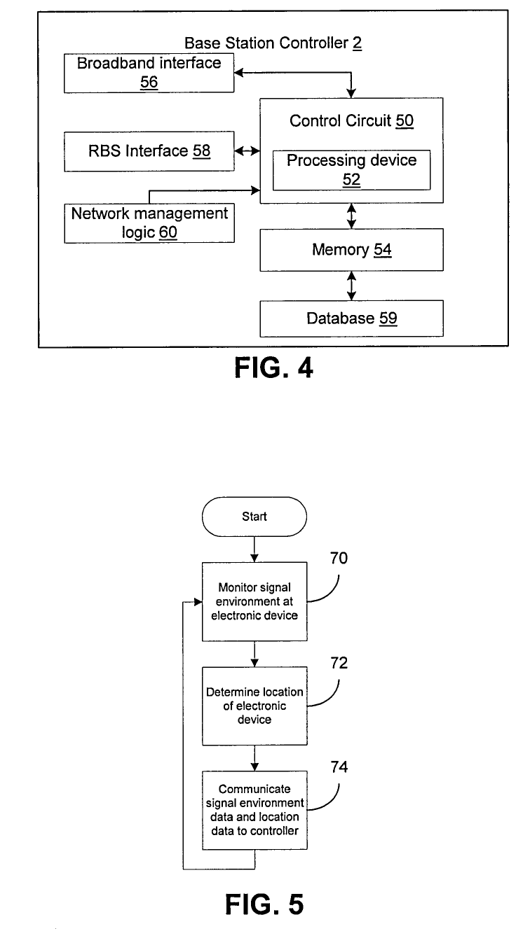

Moving now to FIG. 4, there is shown an exemplary base station controller 2 in accordance with an embodiment of the invention. The base station controller 2 provides the intelligence behind the radio base stations 4a and 4b and the femtocells 6a and 6b. In particular, the base station controller 2 handles allocation of radio channels, receives measurements from mobile phones 10, controls handovers from radio base stations to radio base station, etc.

The base station controller 2 also includes a control circuit 50 that is configured to carry out overall control of the functions and operations of the base station controller 2. The control circuit 50 may include a processing device 52, such as a CPU, microcontroller or microprocessor. The processing device 52 executes code stored in a memory 54 in order to carry out operation of the base station controller 2. The memory 54 may include a read only memory area that is implemented using nonvolatile memory, and a random access or system memory area that is implemented using volatile memory.

The base station controller 2 further includes a broadband interface 56 for communicating with the femtocells 6a and 6b, and a radio base station interface 58 for communicating with the radio base stations 4a and 4b. The broadband interface 56 and radio base station interface 58 may be conventional interfaces known in the art.

A database 59 or the like may be stored in memory 54 of the base station controller 2, or the database 59 may be remotely stored and accessible by the base station controller 2 via the broadband interface 56, for example. The database 59 can include information pertaining to a map of femtocells within the communication network as described in more detail below.

The base station controller 2 further includes network management logic 60 for managing the various femtocells 6a and 6b. In particular, the network management logic enables the base station controller 2 to determine how to configure the femtocells so as to minimize interference.

As described above with respect to the signal monitoring logic 48, the network management logic 60 also may be in the form of code stored in memory 54 and executed by the processing device 52. While in the preferred embodiment the network management logic is executed by the processing device 52, the network monitoring logic 60 may be carried out via dedicated hardware, firmware, software, or combinations thereof, without departing from the scope of the invention. Any of these implementations may be referred to as network monitoring logic 60. Further details regarding the network management logic are described below with respect to FIG. 6.

Moving now to FIGS. 5 and 6, illustrated are exemplary logical operations for the signal monitoring logic 48 (FIG. 5) and network management logic 60 (FIG. 6). The flow chart of FIGS. 5 and 6 may be thought of as depicting steps of a method carried out by the mobile telephone 10 and/or base station controller 2. Although FIGS. 5 and 6 show a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

Referring to FIG. 5, the logical flow for the signal monitoring logic 48 may begin at block 70 where the mobile phone 10 monitors the signal environment. As used herein, the term “signal environment” or “local signal environment” refers to the signals present at the current location of the mobile phone and/or detectable by the mobile phone at its current location. In monitoring the signal environment, the mobile phone 10, for example, listens to a) the relative power levels of the serving femtocell and/or nearby femtocells relative to power levels of the WAN, b) the ratios of various signal power levels relative to the general interference present in the environment, and c) nearby frequencies. In other words, the mobile phone 10 listens to the noise that each component in the local area is creating.

In listening to the power levels, the mobile phone 10, for example, may select a particular frequency and/or spreading factor, and then directly measure the power levels of devices detected on the selected frequency and/or spreading factor. Once the measurement is complete, the frequency and/or spreading factor may be changed and the measurement repeated until all frequencies and spreading factors of interest have been covered.

A conventional way in which the signal environment may be monitored or measured is referred to as carrier quality index (CQI). The CQI is a measure of the quality of the common pilot channel. CQI is a well know method of measuring level of signal quality and, therefore, will not be described herein.

Next at block 72, the mobile phone 10, if equipped with GPS functionality 9 or the like), also can collect information regarding its current location. The collected location data may be packaged with the signal environment data so as to enable mapping of the femtocell network as described below.

At block 74, the mobile phone communicates the collected signal environment data and the mobile phone's location data to the base station controller 2. The communication of this data can be via femtocell or radio base station. Once the data has been communicated to the base station controller 2, the method moves back to block 70 and repeats.

In the above manner the mobile phone 10 serves as the proxy for the base station controller 2 to monitor for interference conditions in the signal environment. Thus, the base station controller can be made aware of the particular environment experienced by the mobile phone.

Moving now to FIG. 6, the logical flow for the network management logic 60 may begin at block 80 where the base station controller 2 receives the signal environment data and the mobile phone location data from the mobile phone 10. As noted above, this information can be received from the phone 10 via the femtocell connection, or via the radio base station connection. The information may be temporarily stored in memory 54 of the base station controller 2 for later analysis.

At block 82, the received data is analyzed to see if it includes location data of the mobile phone 10. If the location data is not present, then the method moves to block 86. However, if the location data is present, then at block 84 the base station controller 2 logs the location data in a database. The database may be stored in memory of the base station controller 2, for example, or it may be stored external to the base station controller. Further, the signal environment data corresponding to this location data is also stored in the database. In this manner, a map of the femtocell network can be constructed and maintained by the base station controller 2. As described below with respect to block 90, the map of the femtocell network enables the base station controller 2 to proactively configure the network so as to minimize the likelihood of interference.

At block 86, the received signal environment data is analyzed by the base station controller 2 to determine if interference conditions exist in the signal environment of the mobile phone 10. Analyzing the data can include, for example, comparing relative power levels of the detected signals, transmission frequencies of the signals, spreading codes of the signals, etc.

For example, the relative signal strength of each device (including femtocells and other devices operating in the environment) within the signal environment of the mobile phone can be compared. If the signal strength of a non-serving femtocell is relatively strong (e.g., it is similar in strength or within a predetermined range of the power transmission level of the serving femtocell 6a), then interference may be possible. The base station controller 2 can flag this condition as a possible interference condition.

Interference also may be possible if the serving femtocell 6a and nearby non-serving femtocells 6b are operating on the same channel (e.g., on the same frequency). The base station controller 2, by detecting the frequencies of the respective femtocells (or other devices in the signal environment of the mobile phone), can flag this condition as another possible interference condition.

Interference is also possible between the femtocell or femtocell network and the WAN (i.e., the radio base stations). As noted above, interference between the femtocell and WAN is possible in TDD systems, but not FDD systems. This situation may be detected by analyzing power levels and/or frequencies of the femtocell relative to that of a nearby radio base station. If the possibility of interference is detected, the base station controller 2 may flag this condition as well.

In addition to analyzing the received signal environment data in its own right, the base station controller 2 also analyzes the received signal environment data relative to the mapped information as stored in the database. By storing the relative location of femtocells in the network, possible interfering signals that are not currently present or were not detected by the mobile phone 10 can be anticipated, and corrective action can be taken prior to the actual occurrence of interference. For example, it may be known from a previous data collection session (which was stored in the database) that a femtocell resides near the current location of the mobile telephone 10. This nearby femtocell, however, may not have been detected by the mobile phone 10 (e.g., it may have been turned off, shielded from the phone, etc.). However, in anticipation of this nearby (but not presently detected) femtocell coming back online, the base station controller 2 may compare the recently received signal environment data to previously collected signal environment data for this particular location as stored in the database. In this manner, the base station controller 2 can proactively determine if signal interference may occur from a currently undetected femtocell (or other device), and take action to prevent such interference.

At block 88, the results of block 86 are checked to see if any interference conditions are detected or anticipated (e.g., any flags were set). If no interference conditions are detected or anticipated, then the method moves back to block 80 and repeats. If interference conditions are detected or anticipated, then at block 90 it is determined if the detected or anticipated interference conditions are in connection with a nearby non-serving femtocell (or other device) or with the WAN.

If the detected or anticipated interference is due to a nearby non-serving femtocell 6b, then at block 92 the base station controller 2 commands the non-serving femtocell 6b (or the serving femtocell 6a) to change its signal properties. The commanded changes to the serving or non-serving femtocell are based on the results of block 86. More particularly, if it was determined at block 86 that the serving femtocell 6a and a nearby non-serving femtocell 6b, for example, are operating on the same frequency, then the non-serving femtocell 6b can be commanded to change its channel (i.e., its transmission frequency) and/or its spreading codes. Alternatively, the base station controller 2 may determine it is better for the serving femtocell 6a to change its channel (e.g., changing the channel of the non-serving femtocell may cause interference with another femtocell handing a different party's communications). Additionally, if the power output of a non-serving femtocell 6b is detected to be relatively high in the region of the serving femtocell 6a, then the base station controller 2 may command the non-serving femtocell 6b to reduce its power output.

Moving back to block 90, if it is determined that the detected or anticipated interference conditions may be with the WAN (for TDD systems), then at block 94 the base station controller 2 can command the serving femtocell 6a to change its signal properties (e.g., change its transmission power level, channel, spreading codes, etc.) so as to minimize the likelihood of interference with the WAN. For example, the electronic device 10 can be used to monitor the interference (on the same frequency) but from adjoining time slots, and the information can be provided to the base station controller to make adjustments to the time of the femtocell to minimize the necessary time guard bands. Upon completing block 92 or 94, the method can move back to block 80 and repeat.

Accordingly, a system, device and method for managing a network of femtocells has been described. The system, device and method can minimize the occurrence of interference between femtocells and/or the WAN, thereby improving the level of service provided by such networks.

A person having ordinary skill in the art of computer programming and applications of programming for mobile communication systems would be able in view of the description provided herein to program a mobile phone 10 and base station controller 2 to operate and to carry out the functions described herein. Accordingly, details as to the specific programming code have been omitted for the sake of brevity. Also, while software in the memory of the mobile phone 10 and base station controller 2 may be used to allow the respective devices to carry out the functions and features described herein in accordance with the preferred embodiment of the invention, such functions and features also could be carried out via dedicated hardware, firmware, software, or combinations thereof, without departing from the scope of the invention.

Specific embodiments of the invention have been disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of minimizing signal interference within a wireless network, said wireless network including a controller communicatively coupled to at least one femtocell, wherein said femtocell is operative to wirelessly transmit and receive data, comprising:
using a portable electronic device to collect signal environment data;
analyzing the collected signal environment data; and
based on the analyzed signal environment data, commanding the at least one femtocell to alter at least one signal transmission characteristic.

2. The method according to claim 1, wherein commanding is performed by the controller.

3. The method according to claim 2, wherein using the portable electronic device further includes communicating the collected signal environment data to the controller.

4. The method according to claim 1, wherein analyzing the collected signal environment data includes at least one of:
comparing a power level of the at least one femtocell to a power level of a radio base station of the wireless network; or
comparing a power level of the at least one femtocell to a general interference present in the signal environment data.

5. The method according to claim 4, wherein analyzing further includes determining from the analyzed signal environment data that interference is likely if the compared power levels are within a predetermined range of one another.

6. The method according to claim 1, further comprising:
detecting a location of the portable electronic device; and
associating the collected signal environment data with the detected location of the portable electronic device.

7. The method according to claim 6, wherein associating includes storing the detected location and the collected signal environment data in a database accessible by the controller.

8. The method according to claim 6, wherein detecting the location of the portable electronic device includes using a global positioning system (GPS) receiver of the portable electronic device to determine the location.

9. The method according to claim 1, wherein altering at least one signal transmission characteristic includes changing at least one of i) a transmission frequency of the at least one femtocell, ii) a transmission power level of the at least one femtocell, or iii) a transmission spreading code of the at least one femtocell.

10. The method according to claim 1, wherein collecting signal environment data includes collecting data regarding signal strengths from a serving femtocell, a non-serving femtocell, and/or a radio base station of the wireless network.

11. The method according to claim 1, wherein the at least one femtocell comprises a serving femtocell and a non-serving femtocell, the method further comprising determining from the collected signal environment data if interference is likely between the serving femtocell and the non-serving femtocell.

12. The method according to claim 11, wherein commanding the at least one femtocell includes commanding the non-serving femtocell.

13. The method according to claim 11, wherein commanding the at least one femtocell includes commanding a serving femtocell.

14. A system for minimizing signal interference within a wireless network, comprising:
a controller;
at least one femtocell communicatively couplable to said controller; and
at least one portable electronic device communicatively couplable to said controller, wherein
said at least one portable electronic device is operative to collect signal environment data and communicate the collected signal environment data to said controller, and wherein
said controller is operative to analyze the signal environment data and, based on the analysis, command said at least one femtocell to alter signal transmission characteristics so as to minimize signal interference within the wireless network.

15. The system according to claim 14, wherein said controller is operative to compare power levels of the at least one femtocell to power levels of a radio base station of the wireless network, and/or compare a power level of the at least one femtocell to a general interference present in the signal environment data.

16. The system according to claim 14, wherein said controller is operative to determine from the analyzed signal environment data that interference is likely if the compared power levels are within a predetermined range of one another.

17. The system according to claim 14, wherein said electronic device is operative to detect its current location and communicate the detected location to said controller, and said controller is operative to map femtocells in the network by associating the collected signal environment data with the detected location of said electronic device.

18. The system according to claim 17, wherein said controller is operative to store the map in a database.

19. The system according to claim 14, wherein said controller is operative to command the at least one femtocell to alter at least one of i) a transmission frequency of the at least one femtocell, ii) a transmission power level of the at least one femtocell, or iii) a transmission spreading code of the at least one femtocell.

20. The system according to claim 14, wherein said electronic device is operative to collect data regarding signal strengths from a serving femtocell, a non-serving femtocell, and/or a radio base station of the wireless network.

21. The system according to claim 14, wherein said electronic device is at least one of a mobile phone, pager, electronic organizer, personal digital assistant, or smartphone.

22. A base station controller for controlling the operation of at least a portion of a wireless wide-area network, said controller couplable to at least one femtocell, comprising:
a processor and memory; and
logic stored in said memory and executable by said processor, said logic including
logic that determines configuration parameters for at least one femtocell based on signal environment data of the wireless network.

23. The base station controller according to claim 22, further comprising:
a broadband interface for communicating with said at least one femtocell; and
a radio base station interface for communicating with at least one radio base station.
